(19) United States
(12) Patent Application Publication
(10) Pub. No.: US 2023/0004971 A1
(43) Pub. Date: Jan. 5, 2023

(54) DYNAMIC ONLINE BANKING HONEYPOT ACCOUNT SYSTEM

(71) Applicant: KYNDRYL, INC., New York, NY (US)

(72) Inventors: Cesar Augusto Rodriguez Bravo, Alajuela (CR); David Alonso Campos Batista, Aurora (CR); Desilda Toska, Milano (IT); Romelia H. Flores, Keller, TX (US)

(21) Appl. No.: 17/363,754

(22) Filed: Jun. 30, 2021

(51) Int. Cl. G06Q 20/40; G06Q 20/10; H04L 29/06

(52) U.S. Cl. CPC G06Q 20/4012; G06Q 20/108; H04L 63/1491

(57) ABSTRACT

A computer-implemented method for processing online banking transactions is disclosed. The computer-implemented method includes identifying a first transaction request utilizing an alternate PIN associated with an alternate account linked to a primary account. The computer-implemented method further includes determining that the first transaction request is invalid based on a PIN policy corresponding to the alternate PIN associated with the alternate account linked to the primary account. The computer-implemented method further includes responsive to determining that the first transaction request is invalid, dynamically altering an allowable transaction limit for the alternate account according to the PIN policy.

### BACKGROUND

The present invention relates generally to the field of honeypot systems, and more particularly, to dynamically executing honeypot accounts based on contextual information.

A honeypot is a security designed to detect and counteract unauthorized access or use of a system or account. The term “honeypot” is used in reference to the way the system traps unauthorized users, such as hackers or spammers, so that they can be identified and prevented from further unauthorized access. Similarly, a honeypot account may be one or more decoy accounts, such as a decoy bank account, used to identify and prevent the unauthorized transfer or theft of funds or information.

### SUMMARY

According to one embodiment of the present invention, a computer-implemented method for processing online banking transactions is disclosed. The computer-implemented method includes identifying a first transaction request utilizing an alternate PIN associated with an alternate account linked to a primary account. The computer-implemented method further includes determining that the first transaction request is invalid based on a PIN policy corresponding to the alternate PIN associated with the alternate account linked to the primary account. The computer-implemented method further includes responsive to determining that the first transaction request is invalid, dynamically altering an allowable transaction limit for the alternate account according to the PIN policy.

According to another embodiment of the present invention, a computer program product for processing online banking transactions is disclosed. The computer program product includes one or more computer readable storage media and program instructions stored on the one or more computer readable storage media. The program instructions include instructions to identify a first transaction request utilizing an alternate PIN associated with an alternate account linked to a primary account. The program instructions further include instructions to determine that the first transaction request is invalid based on a PIN policy corresponding to the alternate PIN associated with the alternate account linked to the primary account. The program instructions further include instructions to in response to determining that the first transaction request is invalid, dynamically alter an allowable transaction limit for the alternate account according to the PIN policy.

According to another embodiment of the present invention, a computer system for processing online banking transactions is disclosed. The computer system includes one or more computer processors, one or more computer readable storage media, and computer program instructions, the computer program instructions being stored on the one or more computer readable storage media for execution by the one or more computer processors. The program instructions include instructions to The program instructions include instructions to identify a first transaction request utilizing an alternate PIN associated with an alternate account linked to a primary account. The program instructions further include instructions to determine that the first transaction request is invalid based on a PIN policy corresponding to the alternate PIN associated with the alternate account linked to the primary account. The program instructions further include instructions to in response to determining that the first transaction request is invalid, dynamically alter an allowable transaction limit for the alternate account according to the PIN policy.

### BRIEF DESCRIPTION OF DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a functional block diagram of a network computing environment for an online banking honeypot account system, generally designated 100, in accordance with at least one embodiment of the present invention.

FIG. 2 is a flow chart diagram depicting operational steps for dynamically maintaining and operating an online banking honeypot account system, generally designated 200, in accordance with at least one embodiment of the present invention.

FIG. 3 is a flow chart diagram depicting operational steps for dynamically maintaining and operating an online banking honeypot account system, generally designated 300, in accordance with at least one embodiment of the present invention.

FIG. 4 is a block diagram depicting components of a computer, generally designated 400, suitable for executing a dynamic online banking honeypot system 101 in accordance with at least one embodiment of the present invention.

FIG. 5 is a block diagram depicting a cloud computing environment 50 in accordance with at least one embodiment of the present invention.

FIG. 6 is block diagram depicting a set of functional abstraction model layers provided by cloud computing environment 50 depicted in FIG. 5 in accordance with at least one embodiment of the present invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

The present invention relates generally to the field of honeypot systems, and more particularly, to dynamically executing honeypot accounts based on contextual information.

Embodiments of the present invention recognize that advances in skimming prevention technologies have resulted in an increase in people being accosted, coerced, and/or forced to withdraw funds from automatic teller machines (ATMs). Unfortunately, this problem has become even more prevalent with the advent of cardless ATMs. Cardless ATMs provide access to an account and allows an account holder or authorized users of an account to withdraw money without the need for a physical card. Instead, cardless ATMs rely on account verification via text message or a banking app on your smartphone. Similarly, the increase in the number and frequency of mobile payment services also renders anyone with a mobile device vulnerable to theft of funds. Accordingly, any person with a mobile device can be a potential target for theft of funds, regardless of whether the person has their purse or wallet.

Embodiments of the present invention further recognize that a person under duress can be presented with equally problematic scenarios regardless of whether a person inputs the correct account information. If a person divulges the correct account access information to an unauthorized user, all of the money in the persons bank account will be revealed and accessible to the unauthorized user. On the other hand, if the person provides invalid account access information to the unauthorized user, causing the account to freeze or become inaccessible, the account holder may be prone to increased harm or danger.

Embodiments of the present invention recognize the need to set up one or more ghost (i.e. alternate) bank accounts linked to a primary bank account that have a relatively small amount of money in them so as to not tip off an unauthorized user that they are using a ghost bank account. Embodiments of the present invention create one or more ghost accounts indicating a small amount of money based on contextual information, including one or more of the PIN entered, location that the PIN was entered, time of transaction, and number of times the user has previously used their PIN at or within a particular location. In an embodiment, the amount of funds in a ghost account is dynamically changed based on the particular PIN/account access information entered at a particular location or the amount of times or frequency in which the user has entered their PIN/account access information at a particular location.

The present invention may be a system, a method, and/or a computer program product at any possible technical detail level of integration. The computer program product may include a computer readable storage medium (or media) having computer readable program instructions thereon for causing a processor to carry out aspects of the present.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suit-able combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

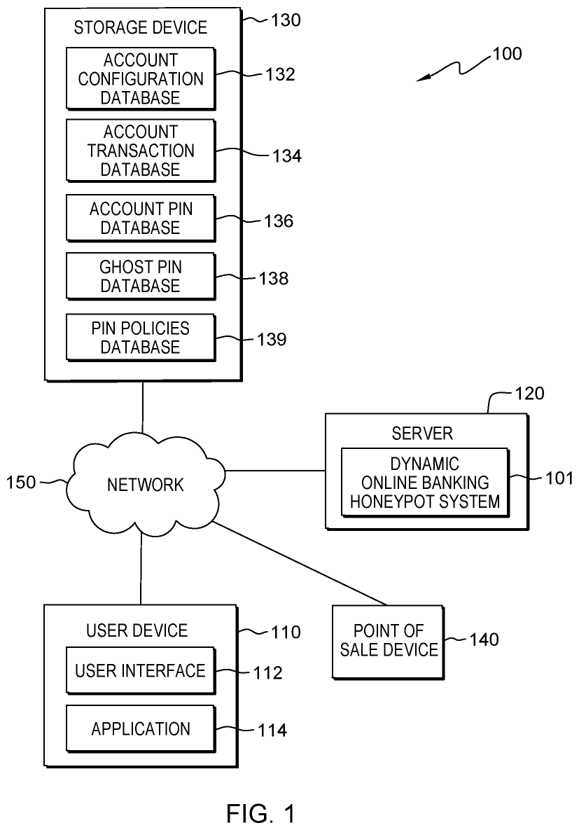

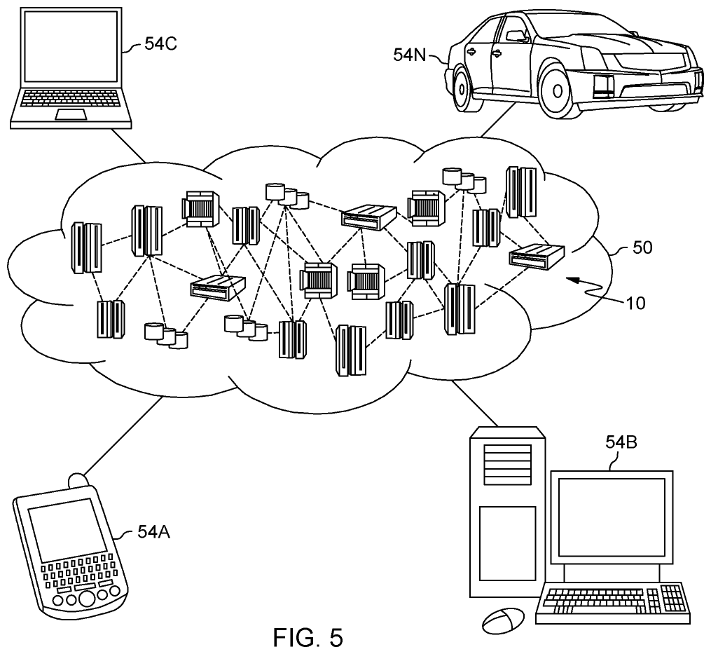

The present invention will now be described in detail with reference to the Figures. FIG. 1 is a functional block diagram of a network computing environment for an online banking honeypot account system, generally designated 100, in accordance with at least one embodiment of the present invention. In an embodiment, network computing environment 100 may be provided by cloud computing environment 50, as depicted and described with reference to FIG. 5, in accordance with at least one embodiment of the present invention. FIG. 1 provides an illustration of only one implementation and does not imply any limitations with regard to the environments in which different embodiments may be implemented. Many modifications to the depicted environment may be made by those skilled in the art without departing from the scope of the present invention as recited by the claims.

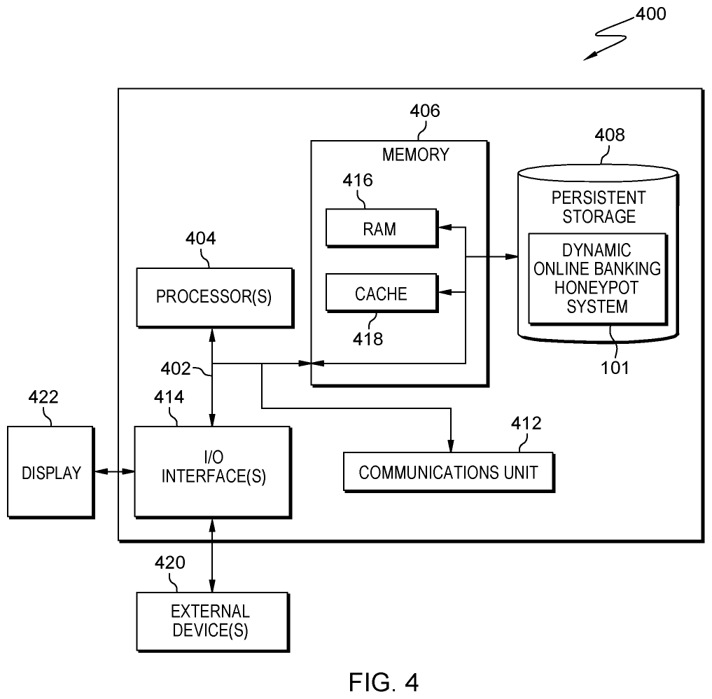

Network computing environment 100 includes user device 110, server 120, storage device 130, and point of sale device 140, all interconnected over network 150. User device 110 may represent a computing device of a user, such as a laptop computer, a tablet computer, a netbook computer, a personal computer, a desktop computer, a personal digital assistant (PDA), a smart phone, a wearable device (e.g., smart glasses, smart watches, e-textiles, AR headsets, etc.), or any programmable computer systems known in the art. In general, user device 110 can represent any programmable electronic device or combination of programmable electronic devices capable of executing machine readable program instructions and communicating with server 120, storage device 130 and other devices (not depicted) via a network, such as network 150. User device 110 may include components as depicted and described in detail with respect to cloud computing node 10, as described in reference to FIG. 5, in accordance with at least one embodiment of the present invention. User device 110 can include internal and external hardware components, as depicted and described in further detail with respect to computing device 400, as described in reference to FIG. 4.

User device 110 further includes user interface 112 and application 114. User interface 112 is a program that provides an interface between a user of an end user device, such as user device 110, and a plurality of applications that reside on the device (e.g., application 114). A user interface, such as user interface 112, refers to the information (such as graphic, text, and sound) that a program presents to a user, and the control sequences the user employs to control the program. A variety of types of user interfaces exist. In one embodiment, user interface 112 is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements. In another embodiment, user interface 112 is a script or application programming interface (API). In an embodiment, user interface 112 displays the users bank account information or displays a QR code to wirelessly unlock an ATM. For example, user interface 112 on user device 110 can display a QR code or passcode which can be scanned or input into point of sale device 140 to complete the transaction.

Application 114 can be representative of one or more applications (e.g., an application suite) that operates on user device 110. In an embodiment, application 114 is representative of one or more applications (e.g., banking applications or mobile payment service applications) located on user device 110. For example, application 114 can be an online mobile banking application that a user of user device 110 utilizes to withdraw or transfer funds via point of sale device 140. In an embodiment, application 114 displays the users bank account information or displays a QR code to wirelessly unlock an ATM. In an embodiment, application 114 can be a client-side application associated with a server-side application running on server 120 (e.g., a client-side application associated with dynamic online banking honeypot system 101). In an embodiment, application 114 can operate to perform processing steps of dynamic online banking honeypot system 101 (i.e., application 114 can be representative of dynamic online banking honeypot system 101 operating on user device 110).

Server 120 is configured to provide resources to various computing devices, such as user device 110. In various embodiments, server 120 is a computing device that can be a standalone device, a management server, a web server, an application server, a mobile device, or any other electronic device or computing system capable of receiving, sending, and processing data. In an embodiment, server 120 represents a server computing system utilizing multiple computers as a server system, such as in a cloud computing environment. In an embodiment, server 120 represents a computing system utilizing clustered computers and components (e.g. database server computer, application server computer, web server computer, webmail server computer, media server computer, etc.) that act as a single pool of seamless resources when accessed within network computing environment 100. In general, server 120 represents any programmable electronic device or combination of programmable electronic devices capable of executing machine readable program instructions and communicating with each other, as well as with user device 110, storage device 130, point of sale device 140, and other computing devices (not shown) within network computing environment 100 via a network, such as network 1_50.

In an embodiment, server 120 includes dynamic online banking honeypot system 101. In an embodiment, dynamic online banking honeypot system 101 may be configured to access various data sources, such as online bank accounts, and mobile payment service accounts that may include personal data, content, contextual data, or information that a user does not want to be processed. Personal data includes personally identifying information or sensitive personal information as well as user information, such as location tracking or geolocation information. In an embodiment, dynamic online banking honeypot system 101 collects the user bank account information, including a user's bank account number, routing numbers, account access information, and various additional information associated with a user's online bank accounts and mobile payment service accounts. In an embodiment, dynamic online banking honeypot system 101 collects information including the frequency, time, and location of the user's transactions, transfers, and fund withdrawals. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. In an embodiment, dynamic online banking honeypot system 101 provides for the authorized and secure processing of personal data. In an embodiment, dynamic online banking honeypot system 101 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. In an embodiment, dynamic online banking honeypot system 101 provides information regarding personal data and the nature (e.g., type, scope, purpose, duration, etc.) of the processing. In an embodiment, dynamic online banking honeypot system 101 provides a user with copies of stored personal data. In an embodiment, dynamic online banking honeypot system 101 allows for the correction or completion of incorrect or incomplete personal data. In an embodiment, dynamic online banking honeypot system 101 allows for the immediate deletion of personal data.

Server 120 may include components as depicted and described in detail with respect to cloud computing node 10, as described in reference to FIG. 5, in accordance with at least one embodiment of the present invention. Server 120 may include components, as depicted and described in detail with respect to computing device 400 of FIG. 4, in accordance with at least one embodiment of the present invention.

In various embodiments, storage device 130 is a secure data repository for persistently storing bank account information, mobile payment service accounts, account access information, etc. utilized by various applications and user devices of a user, such as user device 110. Storage device 130 may be implemented using any volatile or non-volatile storage media known in the art for storing data. For example, storage device 130 may be implemented with a tape library, optical library, one or more independent hard disk drives, multiple hard disk drives in a redundant array of independent disks (RAID), solid-state drives (SSD), random-access memory (RAM), and any possible combination thereof. Similarly, storage device 130 may be implemented with any suitable storage architecture known in the art, such as a relational database, an object-oriented database, or one or more tables.

Storage device 130 includes account configuration database 132, account transaction database 134, account PIN database 136, ghost PIN database 138, and PIN policies database 139. In an embodiment, account configuration database 132 includes various online banking account information associated with a user, including the account numbers associated with a particular user, account owners, account co-owners, and authorized users of a particular banking account. In an embodiment, account transaction database 134 includes a transaction history associated with user banking accounts, including account balances, account transaction amounts, number of transactions related to a particular account, frequency of transactions for a particular account, third party account information in those instances where a user transfers funds to another parties account, location of transactions utilizing a particular account, and the point of sale device or application used to make a transaction. In an embodiment, account transaction database 134 includes information on when and where a banking card, such as a debit or credit card, linked to the account is used. For example, if a user uses their debit card for a $20 ATM withdrawal at a gas station in Boston, Mass., dynamic online banking honeypot system 101 will store the location of the transaction, the time of the transaction, and the amount of the transaction in account transaction database 134. In an embodiment, account transaction database 134 includes information on the number of times or frequency the user uses their banking card, such as a debit or credit card, at certain locations. For example, if a user makes a transaction with their debit card twice a week at an ATM at gas station A in Boston, Mass. and once a week at a restaurant in Somerville, Mass., dynamic online banking honeypot system 101 will store this information in account transaction database 134.

In an embodiment, account PIN database 136 includes various account access information (i.e., information to login or access a particular account), including primary account numbers, and primary account PINs or passwords. The account PIN or password can include any information such as a QR code, numerical, or alphabetical code required to gain access to the bank account. In an embodiment, ghost PIN database 138 includes various ghost account access information (i.e., information to login or access a particular account), including ghost account numbers, and ghost account PINs or passwords. In an embodiment, a ghost account PIN is an alternate PIN associated with an alternate account linked to a primary account.

As used herein, a ghost account shall mean an alternate account linked to a primary account and a ghost PIN shall mean an alternate PIN used to access an alternate account linked to a primary account. As used herein, the terms ghost account and ghost PIN may be used interchangeably with the terms alternate account and alternate PIN. Each ghost account is accessible via a unique PIN and includes a subset or percentage of the funds included in a user's primary account. In an embodiment, the balance of a ghost account can be dynamically altered to include a greater or lesser percentage of the funds included in a user's primary account. For example, a user's primary account may include $10,000 and is accessible by entering the PIN 123. Similarly, a first ghost account linked to the user's primary account may include $1,000 (10% of the balance of the primary account) and is accessible by entering the PIN 456, and a second ghost account linked to the user's primary account may include $100 (1% of the balance of the primary account) and is accessible by entering the PN 789. However, the first ghost account may be altered to reflect a $2,000 balance (20% of the balance of the primary account) and the second ghost account may be altered to reflect a $10 balance (0.1% of the balance of the primary account). In an embodiment, if money is withdrawn from a ghost account, the primary account is updated to reflect the current balance amount. For example, if the primary account balance is $10,000 and $1,000 is withdrawn from the first ghost account, then the primary account balance is updated to $9,000.

In an embodiment, PIN policies database 139 includes a dynamic set of rules for automatically determining an optimized decision or action(s) with respect to a user's online banking accounts. In an embodiment, PIN policies database 139 includes a dynamic set of rules learned from a reinforcement learning algorithm. In an embodiment, PIN policies database 139 includes information describing different decision-making actions that dynamic online banking honeypot system 101 should take based on contextual information associated with a user. In an embodiment, dynamic online banking honeypot system 101 determines if a transaction is valid or invalid based on one or more PIN policies corresponding to the received PIN. In an embodiment, dynamic online banking honeypot system 101 may include a different set of rules for when and where a PIN for accessing an account can be received. For example, PIN policies database 139 may include one set of rules for if a PIN is received in Boston, Mass. versus Los Angeles, Calif. Continuing with this example, dynamic online banking honeypot system 101 may display 100% of a user's bank account balance when the user is in Boston, Mass., but a ghost account that displays only 10% of the user's total bank account balance when the user is in Los Angeles, Calif.

In an embodiment, a separate PIN policy is created for each PIN used to access a primary account and one or more ghost accounts. In an embodiment, a PIN policy includes one or more rules for dynamically altering a ghost account balance based on a time of day. In an embodiment, dynamic online banking honeypot system 101 determines that a transaction request is invalid based, at least in part, on determining that a time at which the transaction was initiated is outside of a predetermined allowable time period indicated by the PIN policy. For example, if a rule states that the first ghost account may include $1,000 from 9 am-5 pm, but only $100 from 5 pm-9 am, then dynamic online banking honeypot system 101 dynamically alters the balance of the first ghost account based on the time of day and the particular amount specified by the rule. In an embodiment, a PIN policy includes one or more rules for dynamically altering a ghost account balance based on a location of a user device used to initiate an online banking transaction. For example, if a rule states that the second ghost account may include $100 if the user is in Buffalo, N.Y., $200 if the user is in Rochester, N.Y., and $300 if the user is in Syracuse, N.Y., then dynamic online banking honeypot system 101 dynamically alters the balance of the second ghost account based on a determined location of the user and the particular amounts for particular locations specified by the rule. In an embodiment, an account balance of a ghost account is dynamically altered based on a number of transactions initiated within a particular geographic location or at a particular point of sale device. In an embodiment, dynamic online banking honeypot system 101 determines a transaction request is invalid if based, at least in part, on determining that a number of transaction requests utilizing the alternate PIN associated with the alternate account linked to the primary account exceeds a predetermined number of transaction requests within a predetermined period of time indicated by the PIN policy. For example, if a rule states that if two transactions are initiated using the first ghost account within a 2 minute period, then dynamic online banking honeypot system 101 automatically changes the account balance of the first ghost account to zero based on detecting two transactions for the same account initiated within a 2 minute period. In another example, if a rule states that if two transactions are initiated using the second ghost account on the same ATM within 24 hours, then dynamic online banking honeypot system 101 automatically changes the balance of the second ghost account to 1% of the total balance of the user's primary account if two transactions are initiated on the same ATM within 24 hours.

In an embodiment, point of sale device 140 is any device where a transaction or withdrawal is attempted. In an embodiment, point of sale device 140 is the device which the PIN number or password is entered on or transmitted to. For example, point of sale device 140 can include an ATM, cardless ATM, a bank, a store, a stationary terminal, a point of sale terminal, an online or mobile banking platform or banking application, or a mobile device, such as user device 110. In an embodiment, a cardless ATM includes a device which provides access to a user's account or the ability to withdraw funds or deposit funds without the need for a physical card. Instead, cardless ATM's rely on account verification via a two factor verification system, such as a one-time password, PIN, or QR code received via a mobile banking application, text message or email of a user device, such as user device 110. In an embodiment, dynamic online banking honeypot system 101 may determine that a request is invalid and generate a message indicating insufficient funds. In an embodiment, dynamic online banking honeypot system 101 displays the message indicating insufficient funds on user device 110 and/or point of sale device 140.

In an embodiment, dynamic online banking honeypot system 101 determines whether a transaction request associated with a primary account or a ghost account is valid based on a PIN policy associated with the account. In an embodiment, whether a transaction request is valid is based, at least in part, on one or more of: (i) the particular PIN or account password received, (ii) a location at which the PIN or account password is received from, (iii) a time at which the PIN or account password is received, (iv) a location at which a transaction is made using a particular account and PIN/password combination, (v) the particular point of sale device that the transaction request was initiated on, and (vi) a number of times the user previously has used their PIN/password at a particular location and/or on a particular point of sale device to initiate a transaction request.

In an embodiment, dynamic online banking honeypot system 101 identifies that a PIN has been entered by a user. In an embodiment, the PIN is received by a mobile banking application platform, mobile payment service platform, or point of sale device, such as an ATM or cardless ATM. In an embodiment, the PIN is representative of a PIN, password, code, or QR code. In an embodiment, dynamic online banking honeypot system 101 determines one or more PIN policies for respective online banking accounts of a user. In an embodiment, the PIN policy is selected based on the PIN, password, code or QR code received. In an embodiment, the PIN policy is selected based on one or more of the locations that a PIN is received from, the time of receipt of a PIN, and a number of times the user previously has used their PIN at the same location or on the same point of sale device. For example, if a ghost PIN is received from an ATM that the user has never visited before, the PIN policy may include a rule to display a ghost account amount of 10% of a primary bank account linked to the ghost account. In another example, if a PIN is received from a cardless ATM that the user typically visits three times a week, the PIN policy may include a rule to determine that the transaction is valid and display the full bank account balance to the user. In another example, if two ghost PINs are received from the same or different location within a predetermined amount of time, the PIN policy may include a rule to shut down all bank accounts associated with the user.

In an embodiment, dynamic online banking honeypot system 101 determines if an online banking transaction is valid. In an embodiment, dynamic online banking honeypot system 101 determines if the online banking transaction is valid based on the PIN received. For example, if 0333 is a ghost PIN and 0529 is the primary account PIN, if dynamic online banking honeypot system 101 receives PIN 0333, it will determine the transaction is invalid. In an embodiment, dynamic online banking honeypot system 101 determines if the transaction request is valid based on the amount requested. In an embodiment, dynamic online banking honeypot system 101 determines if a transaction request is invalid based on the location of a device that initiated the transaction request being outside of a predetermined allowable geographic area indicated by the PIN policy. For example, if the user typically requests $100 from an ATM in Boston, Mass., but then is requesting $1000 from an ATM in Austin, Tex., dynamic online banking honeypot system 101 may determine the transaction is invalid. In an embodiment, if it is determined that a transaction for a ghost account is valid, dynamic online banking honeypot system 101 authorizes the transaction request and updates the primary account balance based on the transaction amount associated with the ghost account.

In an embodiment, dynamic online banking honeypot system 101 shuts down the primary bank account based on the PIN policy. In an embodiment, if the PIN policy determines the primary bank account needs to be shut down, dynamic online banking honeypot system 101 shuts down or freezes the primary bank account for a predetermined period of time.

In an embodiment, dynamic online banking honeypot system 101 dynamically adjusts a ghost account balance based on the PIN policy. For example, dynamic online banking honeypot system 101 dynamically adjusts the ghost account based on one or more of the time of day the PIN is used, the location the PIN is used, and the frequency the PIN has been used at a particular location or device in the past. For example, a PIN received from an ATM the user frequents almost every Friday at 5 pm will trigger dynamic online banking honeypot system 101 to adjust the ghost account balance to a higher amount than a PIN received from an ATM in a city a PIN has never been received from for a user. For example, if a PIN is received from an ATM in Buffalo, N.Y. where dynamic online banking honeypot system 101 has never received a PIN from for this account, the PIN policy includes a rule to adjust the ghost account balance to 10% of the normal bank account balance. Typically, when a PIN is received from a location the user has never provided a PIN from before, the higher probability that the transaction request is suspicious. In this example, dynamic online banking honeypot system 101 adjusts the balance of the ghost account to reflect 10% of the normal bank account balance. In this example, if there is $10,800 in the normal bank account, dynamic online banking honeypot system 101 adjust the balance of the ghost account to $1080. In an embodiment, dynamic online banking honeypot system 101 generates a message indicating the dynamically altered allowable transaction limit. In an embodiment, dynamic online banking honeypot system 101 displays the message indicating the dynamically altered allowable transaction limit on user device 110 and/or point of sale device 140. In this example, dynamic online banking honeypot system 101 displays the message indicating the dynamically altered allowable transaction limit on point of sale device 140 is $1080.

In another embodiment, if the PIN received is from an ATM in Austin, Tex. the user frequents one or twice a week at 5 pm, and the PIN policy includes a rule to adjust the ghost account balance to 50% of the normal bank account balance, then dynamic online banking honeypot system 101 adjusts the balance of the ghost account to reflect 50% of the normal bank account balance. In this example, if there is $10,800 in the normal bank account, dynamic online banking honeypot system 101 adjusts the balance of the ghost account to $5400. However, in this same example, if a PIN is received from the same ATM in Austin, Tex. at 3 am on a Sunday, it is more likely that the transaction request is suspicious, and thus, dynamic online banking honeypot system may be triggered to adjust the ghost account balance by a greater amount (e.g., 20% of the primary account balance).

In an embodiment, dynamic online banking honeypot system 101 displays the ghost account balance. In an embodiment, dynamic online banking honeypot system 101 displays the ghost account balance on the ATM or user device 110. In an embodiment, dynamic online banking honeypot system 101 displays a message indicating the particular ATM the dynamic online banking honeypot system 101 received the PIN from can only dispense a maximum amount of money. For example, dynamic online banking honeypot system 101 displays a message of “Insufficient funds for this transaction”.

In an embodiment, dynamic online banking honeypot system 101 identifies a second transaction request utilizing the alternate PIN associated with the alternate account linked to the primary account and determines that the second transaction request is invalid based on the PIN policy corresponding to the alternate PIN policy associated with the alternate account linked to the primary account. In an embodiment, responsive to determining that the second transaction request is invalid, dynamic online banking honeypot system 101 dynamically alters an account balance of the alternate account to zero and displays a third message on a point of sale device indicating a zero account balance.

In an embodiment, the account balance limit and the account transaction limit are two different monetary amounts. In an embodiment, the account balance limit is the maximum balance that a ghost account can have. In an embodiment, the account transaction limit is the maximum about of funds that can be transferred or withdrawn via user device and/or point of sale device 140. In an embodiment, dynamic online banking honeypot system 101 dynamically alters an account balance limit of the alternate account based, at least in part, on a time the first transaction request is initiated and an allowable account balance limit corresponding to the time indicated by the PIN policy. In an embodiment, dynamic online banking honeypot system 101 dynamically alters an account balance limit of the alternate account based, at least in part, on a location of a device that initiated the first transaction request and an allowable account balance limit corresponding to the location indicated by the PIN policy. In an embodiment, dynamic online banking honeypot system 101 dynamically alters an account balance limit of the alternate account based, at least in part, on a particular device that initiated the first transaction request and an allowable account balance limit corresponding to the particular device indicated by the PIN policy. In an embodiment, dynamic online banking honeypot system 101 dynamically alters an account balance limit higher if it receives the request from an ATM than a mobile phone.

In an embodiment, dynamic online banking honeypot system 101 dynamically alters an account transaction limit of the alternate account based, at least in part, on a time the first transaction request is initiated and an allowable transaction limit corresponding to the time indicated by the PIN policy. In an embodiment, dynamic online banking honeypot system 101 dynamically alters an account transaction limit of the alternate account based, at least in part, on a location of a device that initiated the first transaction request and an allowable transaction limit corresponding to the location indicated by the PIN policy. In an embodiment, dynamic online banking honeypot system 101 dynamically alters an account transaction limit of the alternate account based, at least in part, on a particular device that initiated the first transaction request and an allowable transaction limit corresponding to the particular device indicated by the PIN policy.

The following is a use case example in accordance with at least one embodiment of the present invention. In a situation where a card holder is coerced by another person to give them their PIN, the card holder can give a PIN 3366 associated with a ghost account containing a balance of $1,000. Dynamic online banking honeypot system 101 receives the ghost PIN of 3366 from an ATM for a first withdrawal request of $2000. In this example, the PIN policy associated with the ghost PIN of 3366 is limited to a $100 a maximum one-time withdrawal amount of $100 per day. Since the first withdrawal request of $2000 is more than the limit of $100 based on the PIN policy associated with the ghost PIN of 3366, dynamic online banking honeypot system 101 generates a message indicating insufficient funds for the first withdrawal request. Dynamic online banking honeypot system 101 then updates the card holders ghost account balance from $1,000 to $100 and displays a message indicating a maximum withdrawal amount of $100. If dynamic online banking honeypot system 101 receives the ghost PIN of 3366 for a second withdrawal request within 24 hours of the first withdrawal request, dynamic online banking honeypot system 101 will determine the transaction is invalid. Accordingly, dynamic online banking honeypot system may display a message indicating an account balance of $0 and restricts access to both the user's primary bank account and any ghost bank account linked to the primary bank account for any additional transactions in order to minimize future impact.

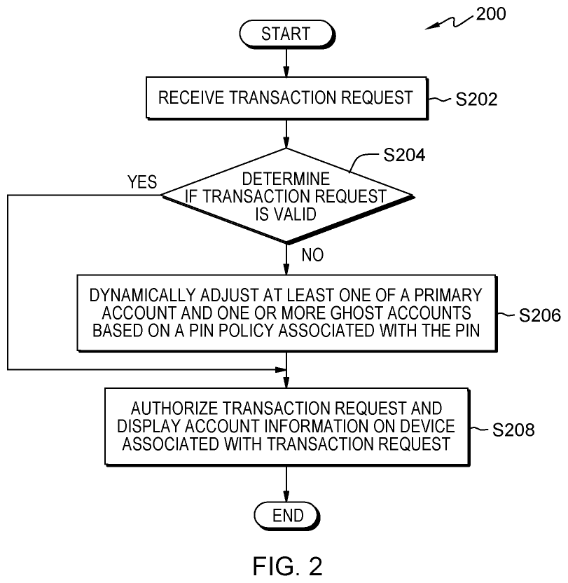

FIG. 2 is a flow chart diagram depicting operational steps for dynamically maintaining and operating an online banking honeypot account system, generally designated 200, in accordance with at least one embodiment of the present invention. FIG. 2 provides only an illustration of one implementation and does not imply any limitations with regard to the environments in which different embodiments may be implemented. Many modifications to the depicted environment may be made by those skilled in the art without departing from the scope of the invention as recited by the claims.

At step S202, dynamic online banking honeypot system 101 receives a transaction request. In an embodiment, the transaction request is received from a mobile banking application platform, mobile payment service platform, or point of service system, such as an ATM or cardless ATM. In an embodiment, the PIN is a PIN, password, code, or QR code. In an embodiment, the PIN, password, or code includes alphabetical or numerical characters. In an embodiment, receiving the transaction request includes an alternate PIN for withdrawal or transfer of funds associated with a user account. In an embodiment, receiving the transaction request includes a primary PIN for withdrawal or transfer of funds associated with a user account. In an embodiment, receiving the transaction request includes logging transaction information corresponding to an account associated with the PIN.

At step S204, dynamic online banking honeypot system 101 determines whether the transaction request is valid. In an embodiment, dynamic online banking honeypot system 101 evaluates generated PIN policies to identify whether the transaction request is valid. In an embodiment, dynamic online banking honeypot system 101 determines whether a transaction is valid/invalid based, at least in part, on one or more of the following: the particular PIN used to initiate a transaction request, a particular location in which the transaction request is initiated, a particular mobile banking application account, mobile payment service account, or point of sale device in which the transaction request was initiated on, a transaction amount (e.g., an amount of funds to be withdrawn or transferred) being in excessive of a predetermined threshold amount or limit, a number of times a particular PIN has been used to initiate a transaction request, and a particular time of day at which the particular PIN is used to initiate a transaction request. In an embodiment, dynamic online banking honeypot system 101 determines the first transaction request is invalid is based, at least in part, on determining that a transaction amount associated with the first transaction request exceeds a maximum allowable transaction amount indicated by the PIN policy.

If it is determined that the first transaction request is valid (decision step S204 “YES” branch), dynamic online banking honeypot system 101 proceeds to step S208. If it is determined that the transaction request is not valid (decision step S204 “NO” branch), dynamic online banking honeypot system 101 proceeds to step S206.

At step S206, in response to determining that the transaction request is invalid, dynamic online banking honeypot system 101 dynamically adjusts at least one of a primary account and one or more ghost accounts based on a PIN policy associated with the PIN. In an embodiment, dynamically adjusting the primary account includes updating the primary account to include a balance of funds that is less than an amount of funds requested to be withdrawn or transferred. For example, the primary account balance is adjusted to a predetermined transaction limit. In an embodiment, dynamically adjusting the primary account includes shutting down the primary account based on a particular PIN being used a predetermined number of times or a predetermined number of times within a predetermined period of time. For example, shutting down the primary account may include prohibiting further access to the primary account, and prohibiting any further transactions from being conducted via the primary account. In an embodiment, adjusting the one or more ghost accounts includes adjusting all ghost account balances to a predetermined amount to minimize future transaction impacts.

At step S208, dynamic online banking honeypot system 101 authorizes a transaction request and displays account balance information on the device associated with the transaction request. In an embodiment, in response to a transaction request being determined to be invalid, dynamic online banking honeypot systems displays a first message on the device associated with the transaction request indicating insufficient funds for the transaction amount. In an embodiment, in response to displaying the first message, dynamic online banking honeypot system 101 displays a second message on the device associated with the transaction request indicating a maximum allowable amount of funds for withdrawal/transfer equal to the adjusted account balance of the primary account. In an embodiment, in response to identifying multiple invalid transaction requests associated with a PIN for accessing a primary account, dynamic online banking honeypot system 101 displays a third message on the device associated with the transaction request indicating an account balance of zero for the primary account.

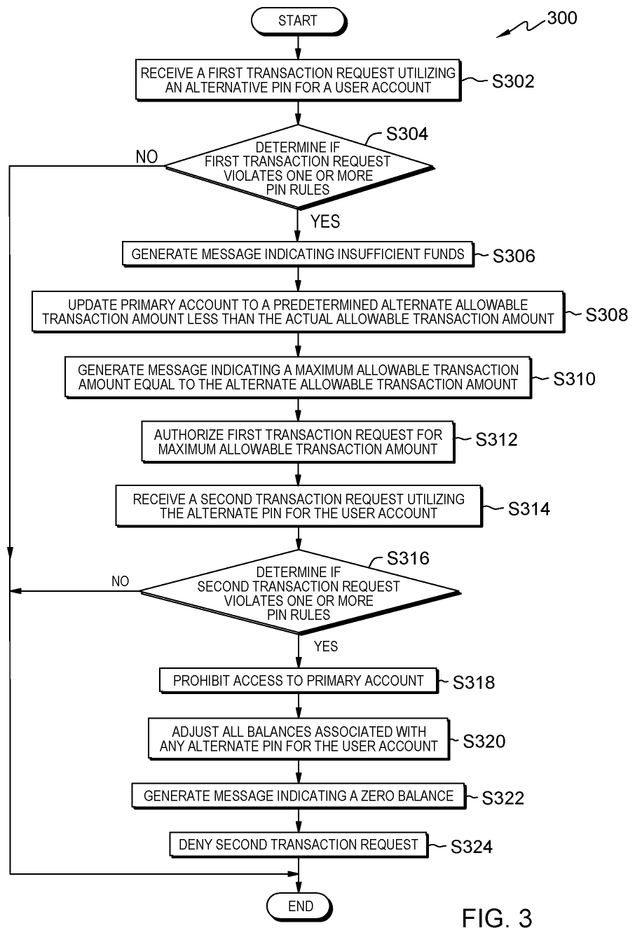

FIG. 3 is a flow chart diagram depicting operational steps for dynamically maintaining and operating an online banking honeypot account system, generally designated 300, in accordance with at least one embodiment of the present invention. FIG. 3 provides only an illustration of one implementation and does not imply any limitations with regard to the environments in which different embodiments may be implemented. Many modifications to the depicted environment may be made by those skilled in the art without departing from the scope of the invention as recited by the claims.

At step S302, dynamic online banking honeypot system 101 identifies a first transaction request utilizing an alternate PIN associated with an alternate account linked to a primary account. In an embodiment, the first transaction request is initiated on user device 110. In an embodiment, the first transaction request is initiated on point of sale device 140.

At decision step S304, dynamic online banking honeypot system 101 determines if the first transaction request is valid. In an embodiment, dynamic online banking honeypot system 101 determines if the first transaction is valid based on a PIN policy corresponding to the alternate PIN associated with the alternate account linked to the primary account. If it is determined that the first transaction request is valid (decision step S304 “YES” branch), dynamic online banking honeypot system 101 proceeds to step S306. If it is determined that the first transaction request is not valid (decision step S304 “NO” branch), dynamic online banking honeypot system 101 authorizes the transaction request and the process ends.

At step S306, in response to determining that the first transaction request is invalid, dynamic online banking honeypot system 101 generates a message indicating insufficient funds. In an embodiment, dynamic online banking honeypot system 101 displays the message on the device that initiated the transaction request, such as user device 110 or point of sale device 140. In an embodiment, dynamic online banking honeypot system 101 displays the message on a device in which a transaction associated with the transaction request is carried out, such as user device 110 or point of sale device 140.

At step S308, further responsive to determining that the first transaction request is invalid, dynamic online banking honeypot system 101 updates the alternate account to a predetermined maximum allowable transaction limit less than the actual allowable transaction limit of the alternate account. In an embodiment, dynamic online banking honeypot system 101 updates the alternate account to an alternative transaction limit based on the PIN policy associated with the alternate account PIN.

At step S310, further responsive to determining that the first transaction request in invalid, dynamic online banking honeypot system 101 generates a message indicating a maximum allowable transaction amount equal to the alternate allowable transaction amount. In an embodiment, dynamic online banking honeypot system 101 displays the message on the device that initiated the transaction request, such as user device 110 or point of sale device 140.

At step S312, dynamic online banking honeypot system 101 authorizes a first transaction request for the alternate allowable transaction amount.

At step S314, dynamic online banking honeypot system 101 receives a second transaction request utilizing the alternate PIN for the user account. In an embodiment, dynamic online banking honeypot system 101 receives a second transaction request from user device 110 or point of sale device 140.

At decision step S316, dynamic online banking honeypot system 101 determines if the second transaction request is valid. In an embodiment, dynamic online banking honeypot system 101 determines if the second transaction is valid based one or more PIN policies corresponding to the received PIN from PIN policies database 139. If it is determined that the second transaction request is valid (decision step S316 “YES” branch), dynamic online banking honeypot system 101 proceeds to step S318. If it is determined that the second transaction request is not valid (decision step S316 “NO” branch), dynamic online banking honeypot system 101 authorizes the transaction request and the process ends.

At step S318, in response to determining that the second transaction request is invalid dynamic online banking honeypot system 101 prohibits access to the primary account. In an embodiment, dynamic online banking honeypot system 101 freezes the primary account.

At step S320, dynamic online banking honeypot system 101 adjusts all balances associated with any alternate bank accounts linked to the primary user account. In an embodiment, dynamic online banking honeypot system 101 adjusts the balances of any alternate bank accounts based on one or more PIN policies associated with the alternate bank accounts.

At step S322, dynamic online banking honeypot system 101 generates a message indicating a balance of zero. In an embodiment, dynamic online banking honeypot system 101 displays the message on the device that initiated the transaction request, such as user device 110 or point of sale device 140.

At step S324, dynamic online banking honeypot system 101 denies the second transaction request.

FIG. 4 is a block diagram depicting components of a computing device, generally designated 400, suitable for dynamic online banking honeypot system 101 in accordance with at least one embodiment of the invention. Computing device 400 includes one or more processor(s) 404 (including one or more computer processors), communications fabric 402, memory 406 including, RAM 416 and cache 418, persistent storage 408, which further includes dynamic online banking honeypot system 101, communications unit 412, I/O interface(s) 414, display 422, and external device(s) 420. It should be appreciated that FIG. 4 provides only an illustration of one embodiment and does not imply any limitations with regard to the environments in which different embodiments may be implemented. Many modifications to the depicted environment may be made.

As depicted, computing device 400 operates over communications fabric 402, which provides communications between computer processor(s) 404, memory 406, persistent storage 408, communications unit 412, and input/output (I/O) interface(s) 414. Communications fabric 402 can be implemented with any architecture suitable for passing data or control information between processor(s) 404 (e.g., microprocessors, communications processors, and network processors), memory 406, external device(s) 420, and any other hardware components within a system. For example, communications fabric 402 can be implemented with one or more buses.

Memory 406 and persistent storage 408 are computer readable storage media. In the depicted embodiment, memory 406 includes random-access memory (RAM) 416 and cache 418. In general, memory 406 can include any suitable volatile or non-volatile one or more computer readable storage media.

Program instructions for dynamic online banking honeypot system 101 can be stored in persistent storage 408, or more generally, any computer readable storage media, for execution by one or more of the respective computer processor(s) 404 via one or more memories of memory 406. Persistent storage 408 can be a magnetic hard disk drive, a solid-state disk drive, a semiconductor storage device, read-only memory (ROM), electronically erasable programmable read-only memory (EEPROM), flash memory, or any other computer readable storage media that is capable of storing program instructions or digital information.

Media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 412, in these examples, provides for communications with other data processing systems or devices. In these examples, communications unit 412 can include one or more network interface cards. Communications unit 412 may provide communications through the use of either or both physical and wireless communications links. In the context of some embodiments of the present invention, the source of the various input data may be physically remote to computing device 400 such that the input data may be received, and the output similarly transmitted via communications unit 412.

I/O interface(s) 414 allows for input and output of data with other devices that may operate in conjunction with computing device 400. For example, I/O interface(s) 414 may provide a connection to external device(s) 420, which may be as a keyboard, keypad, a touch screen, or other suitable input devices. External device(s) 420 can also include portable computer readable storage media, for example thumb drives, portable optical or magnetic disks, and memory cards. Software and data used to practice embodiments of the present invention can be stored on such portable computer readable storage media and may be loaded onto persistent storage 408 via I/O interface(s) 414. I/O interface(s) 414 also can similarly connect to display 422. Display 422 provides a mechanism to display data to a user and may be, for example, a computer monitor.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

FIG. 5 is a block diagram depicting a cloud computing environment 50 in accordance with at least one embodiment of the present invention. Cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

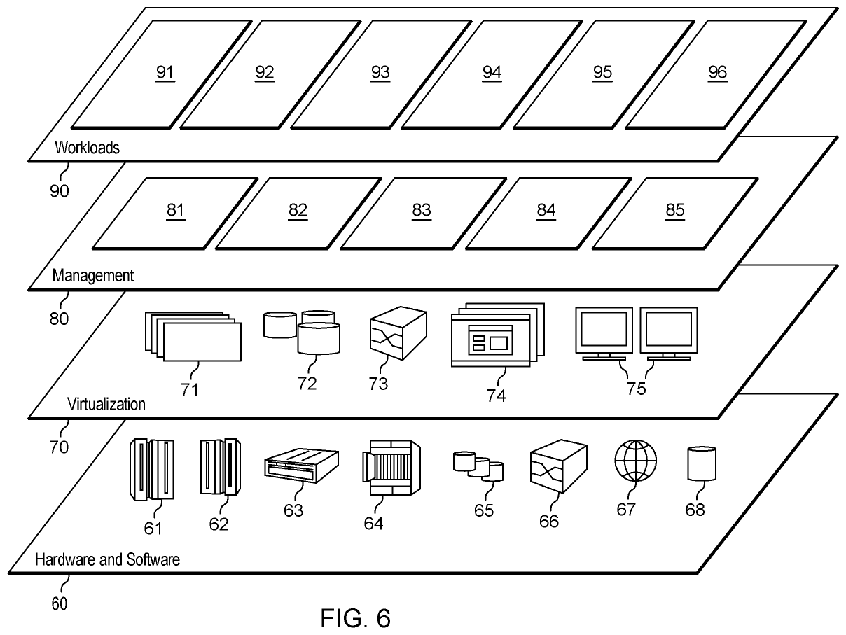

FIG. 6 is block diagram depicting a set of functional abstraction model layers provided by cloud computing environment 50 depicted in FIG. 5 in accordance with at least one embodiment of the present invention. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and online banking honeypot account processing 96.

What is claimed is:

1. A computer-implemented method for processing online banking transactions, the computer-implemented method comprising:
identifying a first transaction request utilizing an alternate PIN associated with an alternate account linked to a primary account;
determining that the first transaction request is invalid based on a PIN policy corresponding to the alternate PIN associated with the alternate account linked to the primary account; and
responsive to determining that the first transaction request is invalid:
dynamically altering an allowable transaction limit for the alternate account according to the PIN policy.

2. The computer-implemented method of claim 1, further responsive to determining that the first transaction request is invalid:
generating a first message indicating insufficient funds; and
displaying the first message indicating insufficient funds on a point of sale device.

3. The computer-implemented method of claim 1, further comprising:
generating a second message indicating the dynamically altered allowable transaction limit; and
displaying the second message indicating the dynamically altered allowable transaction limit on a point of sale device.

4. The computer-implemented method of claim 1, wherein determining that the first transaction request is invalid is based, at least in part, on determining that a location of a device that initiated the first transaction request is outside of a predetermined allowable geographic area indicated by the PIN policy.

5. The computer-implemented method of claim 1, wherein determining that the first transaction request is invalid is based, at least in part, on determining that a time at which the first transaction was initiated is outside of a predetermined allowable time period indicated by the PIN policy.

6. The computer-implemented method of claim 1, wherein determining that the first transaction request is invalid is based, at least in part, on determining that a number of transaction requests utilizing the alternate PIN associated with the alternate account linked to the primary account exceeds a predetermined number of transaction requests within a predetermined period of time indicated by the PIN policy.

7. The computer-implemented method of claim 1, wherein determining that the first transaction request is invalid is based, at least in part, on determining that a transaction amount associated with the first transaction request exceeds a maximum allowable transaction amount indicated by the PIN policy.

8. The computer-implemented method of claim 1, further comprising:
identifying a second transaction request utilizing the alternate PIN associated with the alternate account linked to the primary account;
determining that the second transaction request is invalid based on the PIN policy corresponding to the alternate PIN policy associated with the alternate account linked to the primary account; and
responsive to determining that the second transaction request is invalid:
dynamically altering an account balance of the alternate account to zero; and
displaying a third message on a point of sale device indicating a zero account balance.

9. The computer-implemented method of claim 1, further comprising:
dynamically altering an account balance limit of the alternate account based, at least in part, on a time the first transaction request is initiated and an allowable account balance limit corresponding to the time indicated by the PIN policy.

10. The computer-implemented method of claim 1, further comprising:
dynamically altering an account balance limit of the alternate account based, at least in part, on a location of a device that initiated the first transaction request and an allowable account balance limit corresponding to the location indicated by the PIN policy.

11. The computer-implemented method of claim 1, further comprising:
dynamically altering an account balance limit of the alternate account based, at least in part, on a particular device that initiated the first transaction request and an allowable account balance limit corresponding to the particular device indicated by the PIN policy.

12. The computer-implemented method of claim 1, further comprising:
dynamically altering a transaction limit of the alternate account based, at least in part, on a time the first transaction request is initiated and an allowable transaction limit corresponding to the time indicated by the PIN policy.

13. The computer-implemented method of claim 1, further comprising:
dynamically altering a transaction limit of the alternate account based, at least in part, on a location of a device that initiated the first transaction request and an allowable transaction limit corresponding to the location indicated by the PIN policy.

14. The computer-implemented method of claim 1, further comprising:
dynamically altering a transaction limit of the alternate account based, at least in part, on a particular device that initiated the first transaction request and an allowable transaction limit corresponding to the particular device indicated by the PIN policy.

15. A computer program product for processing online banking transactions, the computer program product comprising one or more computer readable storage media and program instructions stored on the one or more computer readable storage media, the program instructions including instructions to:
identify a first transaction request utilizing an alternate PIN associated with an alternate account linked to a primary account;
determine that the first transaction request is invalid based on a PIN policy corresponding to the alternate PIN associated with the alternate account linked to the primary account; and
responsive to determining that the first transaction request is invalid:
dynamically alter an allowable transaction limit for the alternate account according to the PIN policy.

16. The computer program product of claim 15, further responsive to determining that the first transaction request is invalid, the program instructions including instructions to:
generate a first message indicating insufficient funds; and
display the first message indicating insufficient funds on a point of sale device.

17. The computer program product of claim 15, further comprising instructions to:
generate a second message indicating the dynamically altered allowable transaction limit; and
display the second message indicating the dynamically altered allowable transaction limit on a point of sale device.

18. The computer program product of claim 15, further comprising instructions to:
identify a second transaction request utilizing the alternate PIN associated with the alternate account linked to the primary account;
determine that the second transaction request is invalid based on the PIN policy corresponding to the alternate PIN policy associated with the alternate account linked to the primary account; and
responsive to determining that the second transaction request is invalid:
dynamically alter an account balance of the alternate account to zero; and
display a third message on a point of sale device indicating a zero account balance.

19. The computer program product of claim 15, wherein determining that the first transaction request is invalid is based, at least in part, on determining that a location of a device that initiated the first transaction request is outside of a predetermined allowable geographic area indicated by the PIN policy.

20. A computer system for processing online banking transactions, comprising:
one or more computer processors;
one or more computer readable storage media; and
computer program instructions, the computer program instructions being stored on the one or more computer readable storage media for execution by the one or more computer processors, the computer program instructions including instructions to:
identify a first transaction request utilizing an alternate PIN associated with an alternate account linked to a primary account;
determine that the first transaction request is invalid based on a PIN policy corresponding to the alternate PIN associated with the alternate account linked to the primary account; and
responsive to determining that the first transaction request is invalid:
dynamically alter an allowable transaction limit for the alternate account according to the PIN policy.

21. The computer system of claim 20, further responsive to determining that the first transaction request is invalid, the program instructions including instructions to:
generate a first message indicating insufficient funds; and
display the first message indicating insufficient funds on a point of sale device.

22. The computer system of claim 20, further comprising instructions to:
generate a second message indicating the dynamically altered allowable transaction limit; and
display the second message indicating the dynamically altered allowable transaction limit on a point of sale device.

23. The computer system of claim 20, further comprising instructions to:
identify a second transaction request utilizing the alternate PIN associated with the alternate account linked to the primary account;
determine that the second transaction request is invalid based on the PIN policy corresponding to the alternate PIN policy associated with the alternate account linked to the primary account; and
responsive to determining that the second transaction request is invalid:
dynamically alter an account balance of the alternate account to zero; and
display a third message on a point of sale device indicating a zero account balance.

24. The computer system of claim 20, wherein determining that the first transaction request is invalid is based, at least in part, on determining that a location of a device that initiated the first transaction request is outside of a predetermined allowable geographic area indicated by the PIN policy.

25. The computer system of claim 20, wherein determining that the first transaction request is invalid is based, at least in part, on determining that a transaction amount associated with the first transaction request exceeds a maximum allowable transaction amount indicated by the PIN policy.
